(19) United States
(12) Patent Application Publication
(10) Pub. No.: US 2018/0068308 A1
(43) Pub. Date: Mar. 8, 2018

(54) Authorization Techniques for Fund Sharing Between Accounts

(71) Applicant: CA, Inc., New York, NY (US)

(72) Inventors: Alok Gupta, Bangalore (IN); Gaurav Agarwal, Bangalore (IN); Rahul Gurudas Dhavalikar, Bangalore (IN)

(21) Appl. No.: 15/259,711

(22) Filed: Sep. 8, 2016

(51) Int. Cl. G06Q 20/40; G06Q 20/10; H04W 4/02

(52) U.S. Cl. CPC G06Q 20/401; H04W 4/02; G06Q 20/102

(57) ABSTRACT

Techniques are disclosed relating to authorization of asset sharing between user accounts. In some embodiments, a server-side method includes storing account information for a first user account and receiving a first request to share funds from the first user account with a second user account. In some embodiments, the first request includes one or more constraints on the shared funds. In some embodiments, the method further includes authenticating that the first request was received from a user authorized to share funds from the first user account, receiving a second request that is an authorization request for a payment transaction initiated by the second user account, and authorizing, in response to determining that the second request meets the one or more constraints, the second user account to access the shared funds for the payment transaction. In some embodiments, the shared funds are not transferred from the first user account until after receiving the second request.

### BACKGROUND

### Technical Field

This disclosure relates generally to electronic communications and more particularly to secure authorization of asset sharing between user accounts.

### Description of the Related Art

Various applications are available for performing payment transactions using mobile computing devices. Often, these applications act as a virtual wallet, allowing users to store information for different transaction instruments (e.g., credit cards) and/or maintain a balance one a server. A user may then select from among available payment options when performing a payment transaction (e.g., via a point-of-sale device or a website, for example).

Some applications also allow users to transfer funds to other accounts. For example, a first user may select a payment option and amount to send funds to a friend's account. Transferring an indicated amount of funds at a particular time may not provide desired flexibility for sharing funds with other users.

### SUMMARY

Techniques are disclosed relating to authorization of asset sharing between user accounts. In some embodiments, a server-side method includes storing account information for a first user account and receiving a first request to share funds from the first user account with a second user account. In some embodiments, the first request includes one or more constraints on the shared funds. For example, the first user may specify an expiration time for the sharing, restrictions on location(s) in which shared funds can be used, restrictions on the number of allowed transactions, etc. In some embodiments, the method further includes authenticating that the first request was received from a user authorized to share funds from the first user account. In some embodiments, the method further includes receiving a second request that is an authorization request for a payment transaction initiated by the second user account. In some embodiments, the method further includes authorizing, based on determining that the second request meets the one or more constraints, the second user account to access the shared funds for the payment transaction. In some embodiments, the shared funds are not transferred from the first user account until after receiving the second request.

In some embodiments a device for the first user is configured to display a user interface and receive user input that specifies sharing of funds and constraints on the sharing. In some embodiments, a device for the second user is configured to notify the second user than the funds have been shared and receive user input requesting to use shared funds for a transaction. In some embodiments, fund sharing is performed between user devices that have installed an application and setup accounts on the same centralized payment system.

In various embodiments, disclosed techniques may facilitate sharing funds by allowing senders to share funds without actually sending funds until they are used, as well as allowing senders to impose constraints on the sharing.

### BRIEF DESCRIPTION OF THE DRAWINGS

FIG. 1 is a block diagram illustrating exemplary communications between an authorization server and two mobile devices, according to some embodiments.

FIG. 2 is a diagram illustrating an exemplary interface for sharing funds with another account, according to some embodiments.

FIG. 3 is a diagram illustrating an exemplary interface for accessing shared funds from another account, according to some embodiments.

FIG. 4 is a flow diagram illustrating an exemplary method for authorizing sharing of funds and access to shared funds, according to some embodiments.

FIG. 5 is a flow diagram illustrating another exemplary method for authorizing sharing of funds and access to shared funds, according to some embodiments.

FIGS. 6A and 6B are flow diagrams illustrating exemplary methods performed by sharing and receiving devices respectively, according to some embodiments.

FIG. 7 is a block diagram illustrating an exemplary device, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “mobile device configured to determine device signature information” is intended to cover, for example, a mobile device that performs this function during operation, even if the device in question is not currently being used (e.g., when its battery is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile computing device, for example, would not be considered to be “configured to” perform some specific function, although it may be “configurable to” perform that function. After appropriate programming, the mobile computing device may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

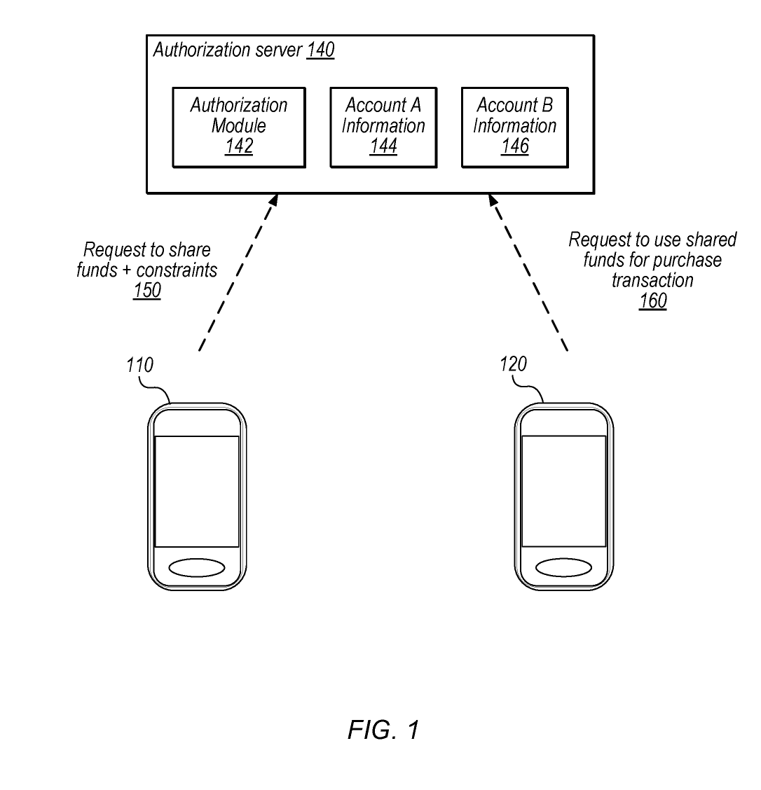

FIG. 1A is a diagram illustrating an exemplary system that includes mobile devices 110 and 120 and an authorization server 140. Elements of FIG. 1 may communicate via any of various appropriate wired and/or wireless electronic communications networks. As one example, each mobile device 110 or 120 may communicate with a cellular wireless base station and/or wireless local area network (WLAN) access point to communicate with a network connected to authorization server 140.

In the illustrated embodiment, devices 110 and 120 are mobile phones, but devices 110 and 120 may be implemented using any of various appropriate mobile devices in other embodiments. In some embodiments, device 110 is configured to share funds with device 120 (and/or vice versa), via authorization server 140.

Device 110, in the illustrated embodiment, is configured to send a message 150 to authorization server 140 that includes a request to share funds and one or more constraints on the sharing. Device 110 may generate and transmit message 150 in response to user input.

Authorization server 140, in the illustrated embodiment, receives message 150 from device 110 and a message 160 from device 120 that requests to use shared funds for a purchase transaction. Authorization server 140 may authenticate one or both of devices 110 and 120. In the illustrated embodiment, authorization server 140 stores account A information 144 and account B information 146. In the illustrated embodiment, account A is for a user of device 110 and account B is an account for a user of device 120. In some embodiments, authorization server 140 creates account B in a time interval between receiving message 150 and receiving message 160. In the illustrated embodiment, authorization server 140 also includes an authorization module 142 configured to perform various actions described herein, including authorize sharing of funds and access to shared funds.

In some embodiments, in response to message 160, authorization server 140 is configured to determine whether to authorize the request to use shared funds. In some embodiments, this includes determining whether the request to use shared funds by device 120 meets the one or more constraints indicated by device 110.

Examples of constraints include, without limitation: geographic constraints, time constraints, amount constraints, number of transactions constraints (which may include a total number of transactions, number of transactions per day, etc.), merchant restrictions (such that shared funds can only be used at certain merchants or groups of merchants), etc.

For example, consider a situation where a sending user, Sara, wants to share funds with a receiving user, Rachel. Sara may have an account with authorization server 140 (or create an account using device 110). The account may be a mobile wallet account. Authorization server 140 may authenticate Sara, e.g., using a username and password and/or other authentication factors. Sara may load funds to the account, e.g., from funding sources such as a bank account or a transaction instrument (e.g., a debit or credit card). Sara may also load information for other funding sources to the account in place of or in addition to adding funds directly. For example, Sara may input a credit card number or bank account information.

Sara may then input commands to share funds with Rachel. For example, Sara may input an amount to be shared and one or more constraints on the sharing. For this example, assume that Sara shares $1000 with the following constraints: the sharing lasts seven days, is for up to five transactions with at most 2 transactions per day, and any transactions must occur within 2 miles of a particular address. Note that in some embodiments, funds are not actually transferred from Sara's account until they are used for a transaction by Rachel.

Sara may specify the recipient of funds (Rachel in this example) using various techniques. In some embodiments, Sara may input a mobile phone number of email address of Rachel. Rachel may receive an email or text message, for example, indicating that funds have been shared. Rachel may already have an account with authorization system 140 or may create an account subsequent to receiving the notification. If Rachel already has an account with authorization server 140, then Sara may identify Rachel using an identifier of Rachel's account. In some embodiments, Rachel may request for funds to be shared and Sara may specify whether to authorize the sharing and constraints for the sharing. Authorization system 140 may authenticate Rachel, e.g., using with a username and password and/or other authentication factors such as a biometric information or an out-of-band one-time password (OTP), for example. Authentication may prevent unauthorized persons from accessing shared funds.

Rachel may then be able to use shared funds as a payment option for payment transactions (e.g., at a point-of-sale device that communicates with device 120 and/or via websites accessed by device 120). Device 120 may notify Rachel of the constraints on the shared funds. For transactions by Rachel that meet the specified constraints, authorization server 140 may transfer funds from Sara's account for use in the transaction (and funds may not be transferred until after the transaction is authorized). In some embodiments, Sara may be able to select whether or not shared funds are accessible to Sara until they are accessed. For example, Sara may be able to access shared funds that have not yet been accessed by Rachel, in some embodiments, reducing the shared amount available to Rachel. In other embodiments, authorization system 140 may not allow Sara to access shared funds until the sharing interval has ended.

Consider a transaction by Rachel that is initiated within the geographic area specified by Sara's constraints, occurs two days after the sharing, and is for $200. Authorization server 140 may be configured to grant this transaction, based on the constraints, and update the shared amount available to $800. Authorization server 140 may also maintain information indicating the total remaining number of allowed transactions (now four) and number of transactions available in that day (now one). In various embodiments, authorization server 140 may store information in one or more electronic data structures to track conditionally-shared funds and constraint status in order to ensure that accesses to shared funds meet specified constraints. In various embodiments, the recipient of shared funds may be notified of the specified constraints in conjunction with a notification that shared funds are available.

The actual transfer of shared funds may involve a reconciliation process, may be performed later as part of a batch transfer, or may be performed immediately as part of the authorization to share funds. The transfer may include moving funds from Sara's account balance to the other entity (the payee) in Rachel's transaction (these funds may be moved directly to the other entity, or indirectly via Rachel's account). The transfer may include obtaining an authorization to charge the funds to another funding source (e.g., a credit card) associated with Sara's account. This may involve additional authentication information (e.g., a CVV value) which may be obtained from Sara at the time of the transaction or pre-obtained. The shared funds may be available to Rachel only for the approved transaction and not usable for other purposes.

Disclosed techniques may facilitate sharing funds by allowing senders to share funds without actually sending funds until they are used, as well as allowing senders to impose constraints on the sharing. This is in contrast to traditional fund transfers, in which the recipient receives the funds right away and the sender relies on the recipient to send back any remaining funds, for example. Further, the constraints may allow a sharing user to control the funds so that the shared funds are used for an intended purpose.

In various disclosed embodiments, funds are shared between user accounts. In other embodiments, any of various appropriate assets may be shared subject to specified constraints including, without limitation: files, physical access, contact information, virtual or digital currency, etc.

### Exemplary User Interfaces

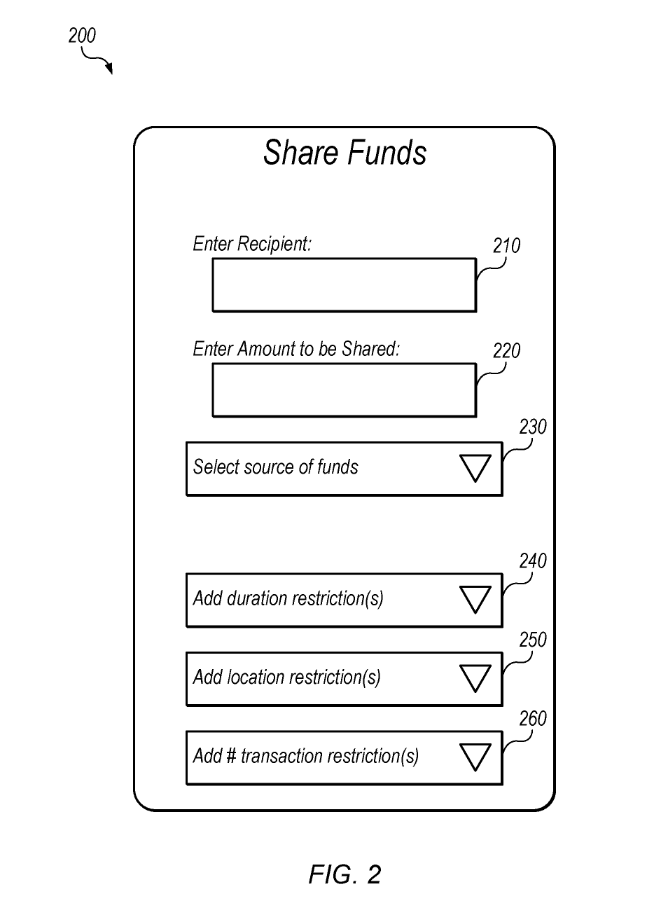

FIG. 2 is a diagram illustrating an exemplary user interface 200 which may be displayed on a sharing user's device, according to some embodiments. In the illustrated embodiment, interface 200 includes fields 210-260. These fields are included for exemplary purposes and are not intended to limit the scope of the present disclosure. In other embodiments, ones of these fields may be omitted and additional fields may be included. In some embodiments, device 110 requires user authentication before use of interface 200.

Field 210, in the illustrated embodiment, allows a sharing user to indicate a recipient for shared funds. In some embodiments, multiple recipients may be specified and funds may be made available to multiple different users, subject to specified constraints. The recipient may be indicated by username, phone number, email address, etc. In some embodiments, field 210 may integrate with contact information stored in device 110 in order to display potential recipients from the user's contacts or allow the user to search their contacts to find a desired recipient.

Field 220, in the illustrated embodiment, allows the sharing user to indicate an amount to be shared. In some embodiments, authorization server 140 and/or device 110 may prevent a sharing user from sharing more funds than are actually available to the sharing user.

Field 230, in the illustrated embodiment, allows the sharing user to select a funding source for funds to be shared. In some embodiments, sharing of only funds in the account itself may be permitted. In these embodiments, the sharing user may transfer funds to the account before sharing the funds. In other embodiments, other sources may be specified such as a credit card account, a bank account, etc. In these embodiments, additional authentication information may be needed to access shared funds, e.g., because the funding source may require additional information before granting the transaction (e.g., a CVV number for credit card transactions). In some embodiments, the sharing user may be prompted for this information. In other embodiment, this information may be stored in the wallet application on device 110.

Field 240, in the illustrated embodiment, allows the sharing user to add one or more restrictions on time interval during which the funds will be shared. In some embodiments, shared funds are no longer available to the recipient after the end of the specified interval.

Field 250, in the illustrated embodiment, allows the sharing user to add one or more location restrictions for transactions by the recipient. For example, this menu may allow the sharing user to set one or more locations and/or one or more acceptable distances from those locations. To ensure that funds are being used appropriately, Sara could require that shared funds can only be used for transactions within 1 mile of a convention center at which Rachel is attending a conference, for example. Location restrictions may also specify one or more entities allowed to be involved in transactions using shared funds. For example, Sara may specify one or more merchants and authorization server 140 may ensure that only transactions at those merchants are authorized to use shared funds.

Field 260, in the illustrated embodiment, allows the sharing user to add one or more restrictions on the number of transactions performed using shared funds. This may include a total limit on transactions, limits over given time intervals (e.g., a per-day limit), etc.

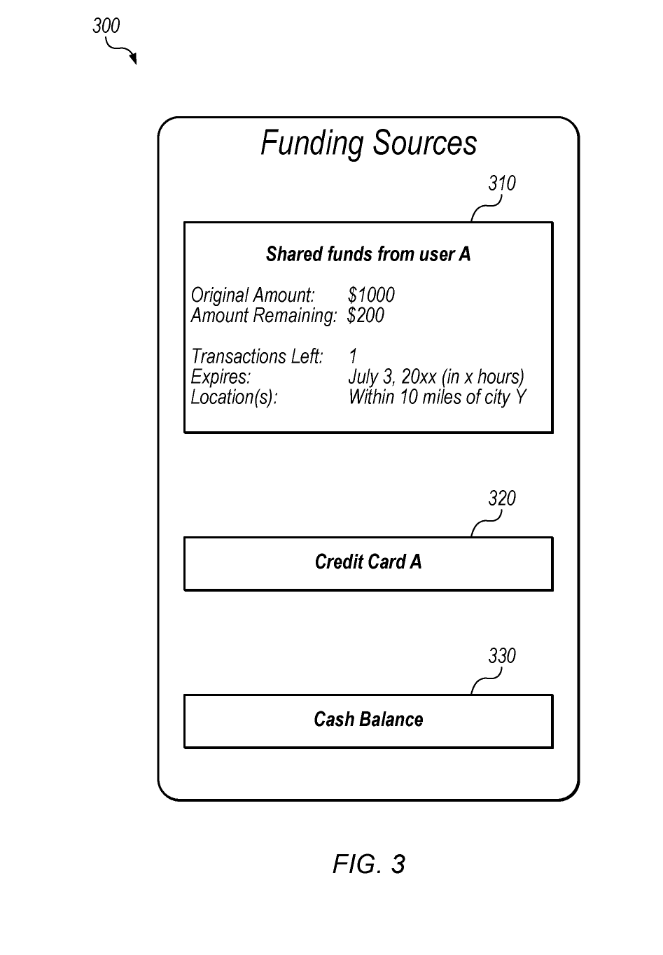

FIG. 3 is a diagram illustrating an exemplary user interface 300 which may be displayed on a receiving user's device, according to some embodiments. In the illustrated embodiment, interface 300 includes fields 310-330. These fields are included for exemplary purposes and are not intended to limit the scope of the present disclosure. In other embodiments, ones of these fields may be omitted and additional fields may be included.

Device 120, in some embodiments, is configured to display interface 300 in response to communications with a point-of-sale device or in response to a checkout process via a website using device 120. This may allow the user to select an appropriate funding source for such transactions.

Fields 310, 320, and 330, in the illustrated embodiment, display different funding sources that are user-selectable for user in a payment transaction. Field 320 is user-selectable to use a credit card A for the transaction. Field 330 is user-selectable to use the cash balance in a user's account for the transaction (e.g., funds previously transferred to the account).

Field 310 is selectable to use shared funds from another user A for the transaction. In the illustrated embodiment, field 310 also indicates one or more constraints on the shared funds. In the illustrated example, $1000 was originally shared but only $200 remains. Further, only one transaction remains and the sharing will expire at a specified date. Still further, the shared funds can only be used within 10 miles of a particular city Y. In other situations, any of various types of constraints may be indicated.

In some embodiments, interface 300 may indicate whether the constraints are currently met. For example, constraints that are not met may be displayed in bold or using a different color. For example, the location restriction in FIG. 3 may be shown in red when the user is more than 10 miles from city Y (showing that the constraint is not met) but may change to another color when the user moves within 10 miles of city Y.

In some embodiments, authorization server 140 is configured to store information indicating whether sharing constraints are met. Authorization server 140 may update this stored information based on updates from user devices. For example, for location-based constraints, geographic location may be determined using cellular base stations, satellite navigation systems, etc. In some embodiments, user device 120 determines its location using the global positioning system (GPS) and reports its determined location to authorization server 140 periodically. In some embodiments, user device 120 reports one or more cellular base stations to which it is connected. In other embodiments, authorization server 140 communicates with a cellular network to determine one or more cellular base stations to which user device 120 is connected. In some embodiments, triangulation may be used to determine the location of device 120 based on nearby cellular base stations. In some embodiments, communicating with a cellular network to determine location may reduce the likelihood that a sharing recipient has maliciously programmed their device to report a false location.

In some embodiments, authorization server 140 is configured to update the stored information for conditionally shared funds each time a transaction occurs, e.g., to reduce the available shared amount.

### Exemplary Methods

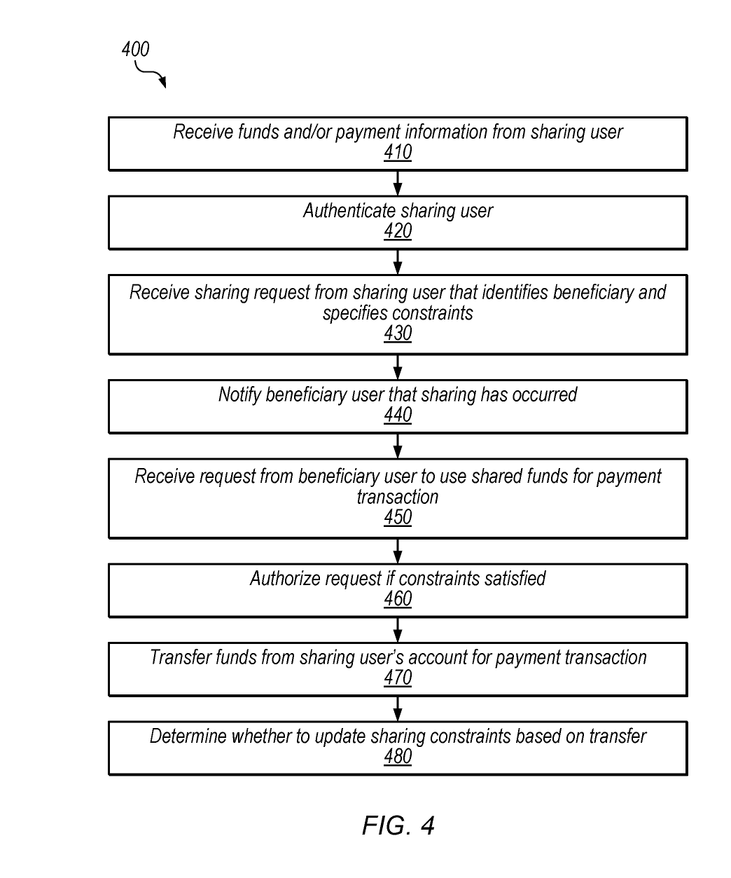

FIG. 4 is a flow diagram illustrating a method 400 for sharing funds between user accounts, according to some embodiments. The method shown in FIG. 4 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 410, in the illustrated embodiment, authorization server 140 receives funds and/or payment information from a sharing user. For example, the sharing user may transfer funds into the account. The sharing user may also input payment instrument information into the account. This may be performed a significant time interval prior to sharing funds (e.g., the sharing user may transfer funds into an account months before deciding to share funds).

At 420, in the illustrated embodiment, authorization server 140 authenticates the sharing user. This may be based on login information, for example and/or additional authentication factors. Authentication may prevent unauthorized users from sharing funds. Authentication may occur before and/or after a user is allowed to request to share funds.

At 430, in the illustrated embodiment, authorization server 140 receives a sharing request from the sharing user that identifies the beneficiary user and specifies one or more constraints. Authorization server 140 may store metadata that monitors the constraints and is used to determine whether to authorize the beneficiary user to access funds for a given transaction.

At 440, in the illustrated embodiment, authorization server 140 notifies the beneficiary user that sharing has occurred. This may include notifying the beneficiary user of constraints on the sharing. The notification may occur via a mobile payment application installed on user device 120, via email, via text message, etc.

At 450, in the illustrated embodiment, authorization server 140 receives a request from the beneficiary user to use shared funds for a payment transaction. In some embodiments, authorization server 140 authenticates the beneficiary user at this stage.

At 460, in the illustrated embodiment, authorization server 140 authorizes the request if the constraints are satisfied.

At 470, in the illustrated embodiment, authorization server 140 transfers funds from the sharing user's account for a payment transaction by the beneficiary user. This may include moving the funds into the beneficiary's account and then using them for the payment transaction or transferring funds directly from the sharing user's account to the beneficiary. In some embodiments, transferring funds may include authorizing the fund transfer at the time of the transaction but the transfer may not place until a later time, e.g., during a batch reconciliation. In various embodiments, step 470 results in a transaction by the beneficiary user being authorized and completed using funds from the sharing user.

At 480, in the illustrated embodiment, authorization server 140 determines whether to update sharing constraints based on the transfer. For example, authorization server 140 may update the shared amount, the number of transactions remaining, etc. In some embodiments, authorization server 140 is configured to notify the sharing user when shared funds have been used for a transaction.

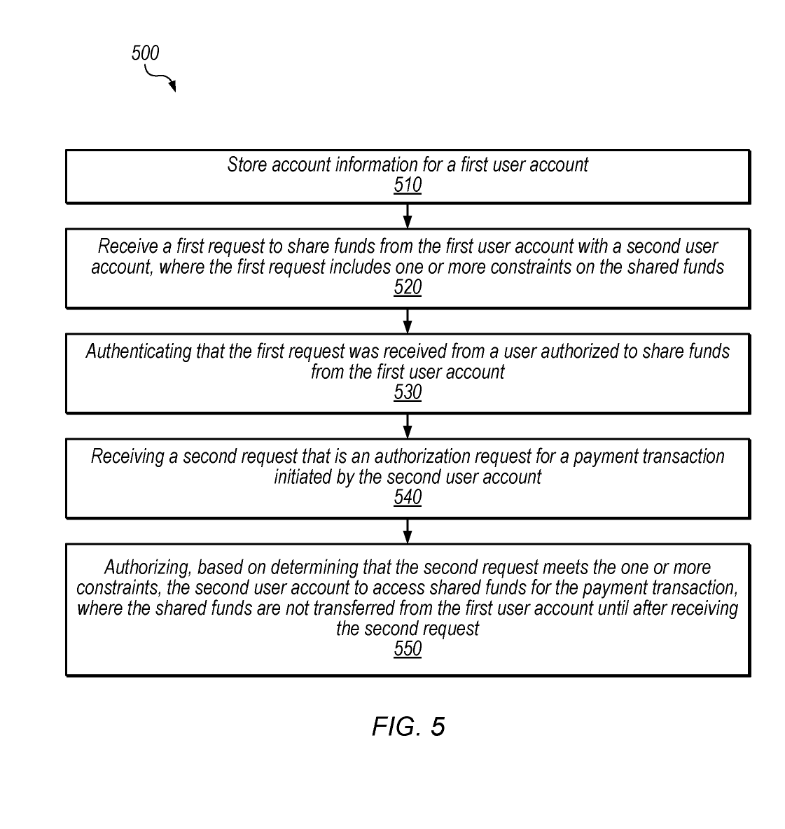

FIG. 5 is a flow diagram illustrating a more generalized method 500 for sharing funds between user accounts, according to some embodiments. The method shown in FIG. 5 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 510, in the illustrated embodiment, authorization server 140 stores account information for a first user account.

At 520, in the illustrated embodiment, authorization server 140 receives a first request to share funds from the first user account with a second user account and the first request includes one or more constraints on the shared funds. Constraints on the shared funds that are included in the first request are different than general constraints or preference constraints that may be maintained by authorization server 140. For example, authorization server 140 may maintain information specifying whether funds can be accessed oversees, or a maximum limit on the duration of fund sharing, where these constraints apply to all users or are set up as preferences for a particular user. In various embodiments, however, the request itself includes constraints for the particular instance of sharing funds. These constraints may be specified using one or more fields of a request format that is known to both authorization server 140 and device 110, for example. Constraints included in the first request may be user-specified for the particular sharing request or may be stored on device 110 as constraint preferences for the first user account. Authorization server 140 may also maintain additional constraints that may be imposed on a given sharing transaction.

At 530, in the illustrated embodiment, authorization server 140 authenticates that the first request was received from a user authorized to share funds from the first user account.

At 540, in the illustrated embodiment, authorization server 140 receives a second request that is an authorization request for a payment transaction initiated by the second user account.

At 550, in the illustrated embodiment, authorization server 140 authorizes, based on determining that the second request meets the one or more constraints, the second user account to access shared funds for the payment transaction. In the illustrated embodiment, the shared funds are not transferred from the first user account until after receiving the second request. Further, in some embodiments funds are not shared until authorization server 140 has authorized the second request. Note that authorization by server 140 may not be the final authorization before the transaction proceeds. For example, if the shared funds are from a credit card of the first user, then the credit card issues may need to authorize the transaction after the authorization by authorization server 140 (e.g., authorization server 140 may authorize a transaction request to be submitted to the card issuer which may then authorize use of the credit card for the transaction).

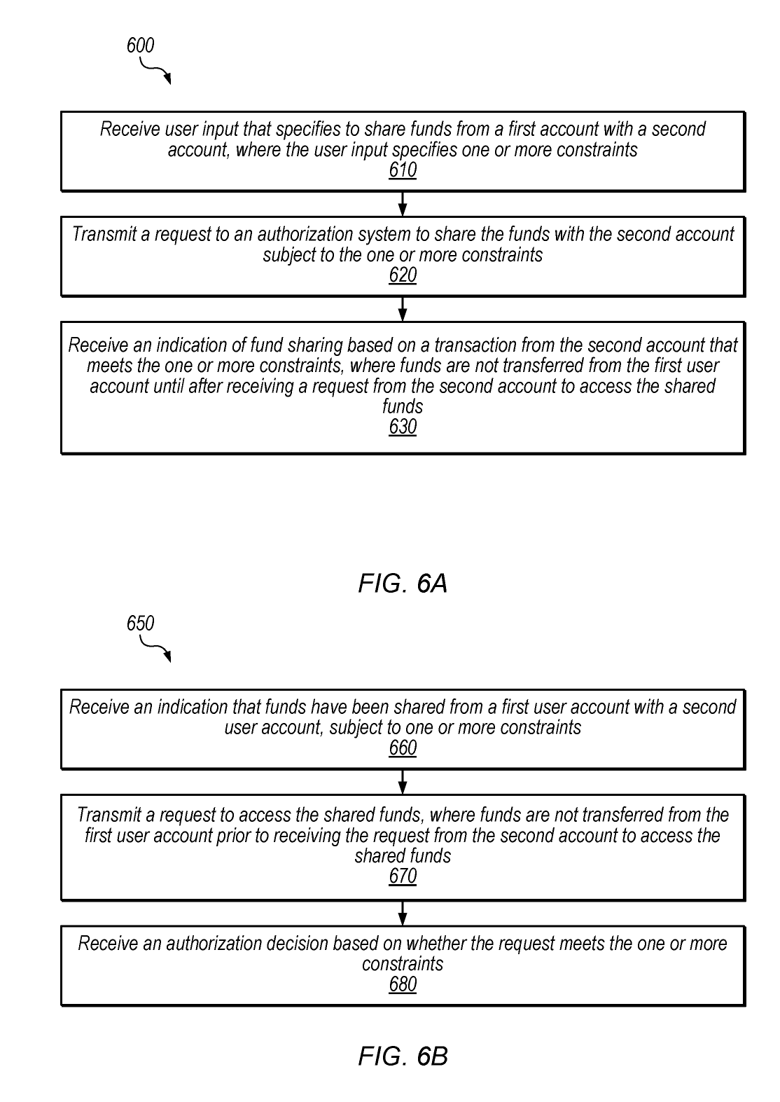

FIG. 6A is a flow diagram illustrating a more generalized method 600 for sharing funds with another user account, according to some embodiments. The method shown in FIG. 6A may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 610, in the illustrated embodiment, device 110 receives user input that specifies to share funds from a first account with a second account and the user input specifies one or more constraints on the sharing.

At 620, in the illustrated embodiment, device 110 transmits a request to an authorization system (e.g., authorization server 140) to share funds with the second account subject to the one or more constraints.

At 630, in the illustrated embodiment, device 110 receives an indication of fund sharing based on a transaction from the second account that meets the one or more constraints. In the illustrated embodiment, funds are not transferred from the first user account until after receiving a request from the second account to access the shared funds. This may allow the first user to retain funds unless they are properly accessed for a transaction for the second user.

FIG. 6B is a flow diagram illustrating a more generalized method 650 for accessing shared funds from another user account, according to some embodiments. The method shown in FIG. 6B may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 660, in the illustrated embodiment, device 120 receives an indication that funds have been shared from a first user account with a second user account (e.g., where the second user account is an account of a user of device 120), subject to one or more constraints. In some embodiments, the second user account has not been created when the indication is received and the user of device 120 creates the second account in response to the indication. For example, if the user of device 110 identifies the intended recipient with a phone number, the funds may be shared with an account created by the user with that phone number.

At 670, in the illustrated embodiment, device 120 transmits a request to access the shared funds (e.g., based on user input). In the illustrated embodiment, the funds are not transferred from the first using account prior to receiving the request.

At 680, in the illustrated embodiment, device 120 receives an authorization decision based on whether the request meets the one or more constraints. In some embodiments, the request includes information that indicates one or more conditions relating to the one or more constraints (e.g., location information for device 120).

In some embodiments, any of various operations discussed herein may be performed by executing program instructions stored on a non-transitory computer readable medium. Such program instructions may be executed using one or more of device 110, device 120, and/or authorization server 140, for example. In these embodiments, the non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

### Exemplary Device

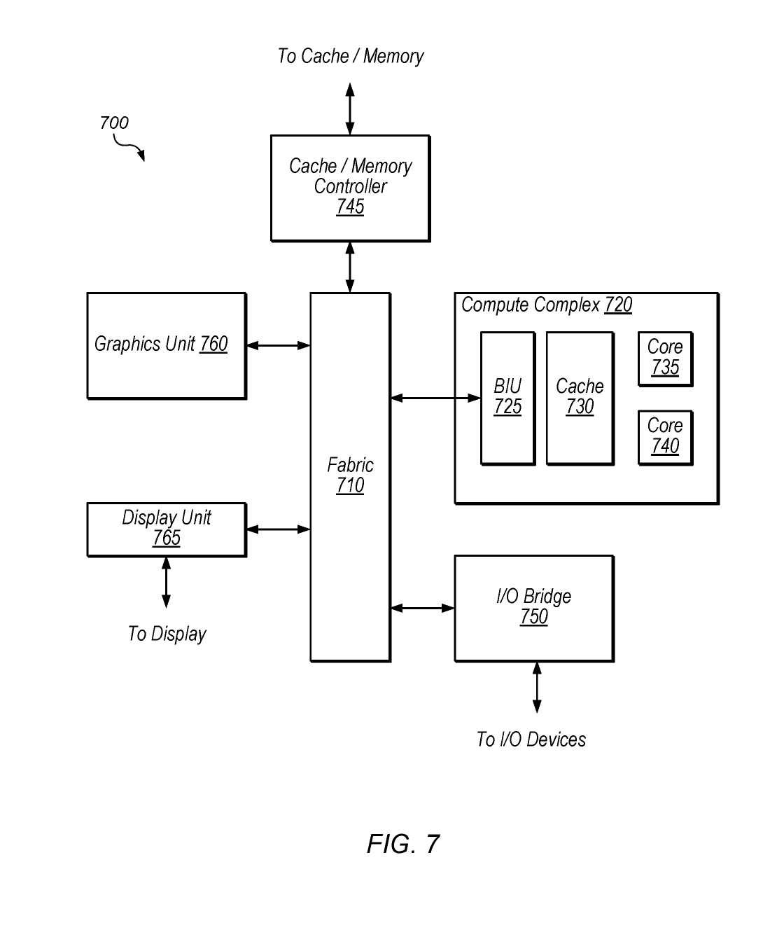

Referring now to FIG. 7, a block diagram illustrating an exemplary embodiment of a device 700 is shown. The illustrated processing elements may be included in devices 110, 120, and/or 140, in some embodiments. In some embodiments, elements of device 700 may be included within a system on a chip. In some embodiments, device 700 may be included in a mobile device, which may be battery-powered. Therefore, power consumption by device 700 may be an important design consideration. In the illustrated embodiment, device 700 includes fabric 710, compute complex 720, input/output (I/O) bridge 750, cache/memory controller 745, graphics unit 760, and display unit 765.

Fabric 710 may include various interconnects, buses, MUX's, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 725, cache 730, and cores 735 and 740. In various embodiments, compute complex 720 may include various numbers of processors, processor cores and/or caches. For example, compute complex 720 may include 1, 2, or 4 processor cores, or any other suitable number. In one embodiment, cache 730 is a set associative L2 cache. In some embodiments, cores 735 and/or 740 may include internal instruction and/or data caches. In some embodiments, a coherency unit (not shown) in fabric 710, cache 730, or elsewhere in device 700 may be configured to maintain coherency between various caches of device 700. BIU 725 may be configured to manage communication between compute complex 720 and other elements of device 700. Processor cores such as cores 735 and 740 may be configured to execute instructions of a particular instruction set architecture (ISA) which may include operating system instructions and user application instructions.

Cache/memory controller 745 may be configured to manage transfer of data between fabric 710 and one or more caches and/or memories. For example, cache/memory controller 745 may be coupled to an L3 cache, which may in turn be coupled to a system memory. In other embodiments, cache/memory controller 745 may be directly coupled to a memory. In some embodiments, cache/memory controller 745 may include one or more internal caches.

As used herein, the term “coupled to” may indicate one or more connections between elements, and a coupling may include intervening elements. For example, in FIG. 7, graphics unit 760 may be described as “coupled to” a memory through fabric 710 and cache/memory controller 745. In contrast, in the illustrated embodiment of FIG. 7, graphics unit 760 is “directly coupled” to fabric 710 because there are no intervening elements.

Graphics unit 780 may include one or more processors and/or one or more graphics processing units (GPU's). Graphics unit 780 may receive graphics-oriented instructions, such as OPENGL® or DIRECT3D® instructions, for example. Graphics unit 780 may execute specialized GPU instructions or perform other operations based on the received graphics-oriented instructions. Graphics unit 780 may generally be configured to process large blocks of data in parallel and may build images in a frame buffer for output to a display. Graphics unit 780 may include transform, lighting, triangle, and/or rendering engines in one or more graphics processing pipelines. Graphics unit 780 may output pixel information for display images.

Display unit 765 may be configured to read data from a frame buffer and provide a stream of pixel values for display. Display unit 765 may be configured as a display pipeline in some embodiments. Additionally, display unit 765 may be configured to blend multiple frames to produce an output frame. Further, display unit 765 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and/or low-power always-on functionality, for example. I/O bridge 750 may also include interfaces such as pulse-width modulation (PWM), general-purpose input/output (GPIO), serial peripheral interface (SPI), and/or inter-integrated circuit (I2C), for example. Various types of peripherals and devices may be coupled to device 700 via I/O bridge 750.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
communication circuitry configured to wirelessly communicate with one or more cellular base stations, wherein location information for the apparatus is determinable based on a which of the one or more cellular base stations are in communication with the communication circuitry;
positioning circuitry configured to determine location based on received signals from one or more satellite units of a satellite navigation system;
one or more processing elements configured to:
receive an indication of sharing of assets of a first user account with a second user account corresponding to a user of the apparatus, wherein the indication specifies one or more location constraints;
receive user input requesting to access the first user account for a transaction of the second user account at a particular location;
transmit a request to access the first user account in response to the user input, wherein the request specifies the particular location based on information from the positioning circuitry; and
receive an authorization of the access to the first user account, wherein the authorization is based on the location constraints, the location information, and a determined location of the apparatus from the positioning circuitry, wherein assets of the first user account are not accessed for sharing with the second user account until after transmission of the request.

2. The apparatus of claim 1, wherein the positioning circuitry is global positioning system (GPS) circuitry and the authorization is received from an authorization server.

3. The apparatus of claim 1, wherein the indication specifies one or more additional constraints on the sharing including an expiration time or a number of transactions.

4. A method, comprising:
storing, by a computing system, account information for a first user account;
receiving, by the computing system, a first request, wherein the first request is a request to share funds from the first user account with a second user account, wherein the first request includes one or more constraints on the shared funds;
authenticating, by the computing system, that the first request was received from a user authorized to share funds from the first user account;
receiving, by the computing system, a second request, wherein the second request is an authorization request for a payment transaction initiated by the second user account; and
authorizing, by the computing system based on determining that the second request meets the one or more constraints, the second user account to access the shared funds for the payment transaction, wherein the shared funds are not transferred from the first user account until after receiving the second request.

5. The method of claim 4, further comprising:
receiving, by the computing system, a third request, wherein the third request is a request to access funds from the first user account for a payment transaction initiated by the second user account; and
in response to determining that the third request does not meet the one or more constraints, processing the third request without permitting the second user account to access the shared funds for the payment transaction.

6. The method of claim 4, wherein the one or more constraints include a time interval after which the shared funds are no longer available for transactions by the second user account.

7. The method of claim 4, wherein the one or more constraints include a restriction on geographic locations in which the shared funds are accessible.

8. The method of claim 7, further comprising determining a location of a device associated with the second user account based on one or more communications of the device with one or more cellular base stations.

9. The method of claim 7, further comprising determining a location of a device associated with the second user account based on satellite navigation information received from the device.

10. The method of claim 4, wherein one or more constraints include a limitation on a number of transactions allowed using the shared funds.

11. The method of claim 4, further comprising generating a token in response to the first request and transmitting the token to a device corresponding to the second user account, wherein the second request includes the token.

12. The method of claim 4, further comprising receiving a prior request from the second user account for shared funds from the first user account and soliciting the first request from the first user account in response to the prior request.

13. The method of claim 4, further comprising creating the second user account in response to the first request.

14. The method of claim 13, wherein the first request includes information usable to initiate communications with a user device associated with the second user account.

15. A non-transitory computer-readable medium having instructions stored thereon that are executable by a computing system to perform operations comprising:
storing account information for a first user account;
receiving a first request, wherein the first request is a request to share funds from the first user account with a second user account, wherein the first request includes one or more constraints on the shared funds;
authenticating that the first request was from a user authorized to share funds from the first user account;
storing conditional funding information indicating that shared funds from the first user account are available to the second user account;
receiving a second request, wherein the second request is an authorization request for a payment transaction initiated by the second user account; and
authorizing, based on determining that the second request meets the one or more constraints, the second user account to access the shared funds for the payment transaction, wherein the shared funds are not transferred from the first user account until after receiving the second request.

16. The non-transitory computer-readable medium of claim 15, wherein the operations further comprise:
receiving a third request, wherein the third request is a request to access funds from the first user account for a payment transaction initiated by the second user account; and
in response to determining that the third request does not meet the one or more constraints, processing the third request without permitting the second user account to access the shared funds for the payment transaction.

17. The non-transitory computer-readable medium of claim 15, wherein the one or more constraints include a time interval after which the sharing expires.

18. The non-transitory computer-readable medium of claim 15, wherein the one or more constraints include a restriction on geographic locations in which the shared funds are accessible.

19. The non-transitory computer-readable medium of claim 15, wherein one or more constraints include a limitation on a number of transactions allowed using the shared funds.

20. The non-transitory computer-readable medium of claim 15, wherein the operations further comprise generating a token in response to the first request and transmitting the token to a device corresponding to the second user account, wherein the second request includes the token.
